(19) United States
(12) Patent Application Publication
(10) Pub. No.: US 2025/0097987 A1
(43) Pub. Date: Mar. 20, 2025

(54) TECHNIQUES TO CONFIGURE A RECONFIGURABLE INTELLIGENT SURFACE DEVICE

(71) Applicant: ZTE Corporation, Shenzhen (CN)

(72) Inventors: Qian DAI, Shenzhen (CN); Yijun CUI, Shenzhen (CN); Ping LI, Shenzhen (CN)

(21) Appl. No.: 18/729,340

(22) PCT Filed: Jan. 17, 2022
(86) PCT No.: PCT/CN2022/072224

§ 371 Date: Jul. 16, 2024

(51) Int. Cl. H04W 74/0833; H04L 1/1812; H04W 52/02; H04W 68/02; H04W 74/00; H04W 76/27

(52) U.S. Cl. CPC H04W 74/0833; H04L 1/1812; H04W 52/0229; H04W 68/02; H04W 74/004; H04W 76/27

(57) ABSTRACT

Techniques are described to configure a reconfigurable intelligent surface (RIS) device or a repeater device. An example wireless communication method includes receiving, by a communication device (e.g., RIS device or a repeater device) from a network device, control information; and configuring the communication device according to the control information.

### CROSS-REFERENCE TO RELATED APPLICATION

The present disclosure is a national stage filing under 35 U.S.C. § 371 of international application number PCT/CN2022/072224 filed Jan. 17, 2022 and entitled “techniques to configure a reconfigurable intelligent surface device”, which is incorporated herein by reference in its entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for design and configuration of reference signal for Reconfigurable Intelligent Surface (RIS) which can also be referred to as intelligent reflective surface. This patent document also describes solutions to the technical problem of how to save energy in the use of RIS control module and reflective panel.

A first wireless communication method includes receiving, by a communication device a from a network device, control information; and configuring the communication device according to the control information.

In some embodiments, a number of transmissions of the control information to be received by the communication device is pre-configured, and the communication device receives from the network device a system message or a dedicated message that indicates the number of transmissions. In some embodiments, the control information is included in a paging message. In some embodiments, the method further comprises receiving, by a communication device from a network device, a paging message that indicates that control information is available for the communication device; initiating, by the communication device, a random access procedure in response to receiving the paging message; and receiving, by the communication device, the control information during the random access procedure.

In some embodiments, the control information is included in msg2 or msg4 in case that the random access procedure being a 4-step random access procedure. In some embodiments, the control information is included in msgB in case that the random access procedure being a 2-step random access procedure. In some embodiments, the communication device initiates the random access procedure using a physical random access channel resource (PRACH) resource dedicated for a reconfigurable intelligent surface (RIS) device, and the PRACH resource is received by the communication device and configured by the network device. In some embodiments, the control information is received using pre-configured downlink resources or pre-scheduled resources. In some embodiments, the pre-configured downlink resources or the pre-scheduled resources include time domain resources and frequency domain resources.

In some embodiments, the pre-configured downlink resources or the pre-scheduled resources are received by the communication device when the communication device is in a radio resource control (RRC) connected state prior to the receiving the control information, and the communication device receives from the network device a system message or a dedicated message that indicates the pre-configured downlink resources or the pre-scheduled resources. In some embodiments, the pre-configured downlink resources or the pre-scheduled resources are valid during a time when the communication device operates a timer that has not expired which indicates that the communication device is synchronized with the network device. In some embodiments, a length of the time is configured by the network device and is received by the communication device from the network device.

In some embodiments, the communication device receives the control information during a radio resource control (RRC) idle state or a RRC inactive state by monitoring for signaling that includes the control information on the pre-configured downlink resources or on the pre-scheduled resources. In some embodiments, the control information includes any one or more of the following: an identifier of the communication device, a first indication to turn on or turn off an RIS reflective panel of the communication device, a second indication that indicates whether to update codebook used to control the RIS reflective panel of the communication device, a codebook content or a codebook index, wherein the codebook index is used to correspond to one of plurality of codebooks stored by the communication device, an effective time or an effective time offset of a codebook, configuration of the RIS reflective panel, or a wake-up purpose indication.

In some embodiments, the configuration of the RIS reflective panel includes any one or more of the following: a RIS reflective panel index, a RIS reflective panel working mode, a RIS reflective panel configuration cycle, a horizontal steering angle of the RIS reflective panel, a vertical steering angle of the RIS reflective panel, or an effective time or an effective time offset of the configuration of the RIS reflective panel. In some embodiments, the wake-up purpose indication indicates whether there is a subsequent information to be received by the communication device, or the wake-up purpose indication includes: a normal wake-up indication that indicates to the communication device to complete a radio resource control (RRC) connection procedure or RRC resume procedure, or a temporary wake-up that indicates to the communication device that the communication device does not need to complete the RRC connection procedure or the RRC resume procedure.

In some embodiments, the communication device sends to the network device a feedback message that indicates that the communication device received the control information in a paging message, and the feedback message is sent by using a dedicated random access preamble configured by the network device or by using a dedicated physical random access channel resource (RACH) configured by the network device for the communication device. In some embodiments, the communication device sends to the network device a feedback message that indicates that the communication device received the control information, and the feedback message is sent in msg3 or msg5 of the 4-step random access procedure. In some embodiments, the communication device sends to the network device a feedback message that indicates that the communication device received the control information, and the feedback message is sent by using network pre-configured uplink wireless resources or pre-scheduled uplink wireless resources.

In some embodiments, the communication device sends to the network device a feedback message that indicates that the communication device received the control information, and the feedback message is sent using a hybrid automatic repeat request (HARQ) acknowledgement/non-acknowledgement (ACK/NACK) response corresponding to the msgB of the 2-step random access procedure in case the control information is received in the msgB. In some embodiments, the communication device sends to the network device a feedback message that indicates that the communication device received the control information, and the feedback message is sent with an acknowledgement (ACK) or non-acknowledgement (NACK) feedback corresponding to the pre-configured downlink resources or the pre-scheduled downlink resources. In some embodiments, the communication device includes a reconfigurable intelligent surface (RIS) device or a repeater device.

A second wireless communication method includes receiving, by a network device from a management function, control information for a communication device; transmitting, by the network device, the control information to the communication device; and transmitting, by the network device to the management function, a confirmation that indicates that the communication device received the control information.

In some embodiments, the control information is included in a paging message. In some embodiments, the control information is included in msg2 or msg4 in case that a random access procedure between the network device and the communication device being a 4-step random access procedure. In some embodiments, the control information is included in msgB in case that a random access procedure between the network device and the communication device being a 2-step random access procedure. In some embodiments, the control information is transmitted using pre-configured downlink resources or pre-scheduled resources.

In some embodiments, the control information includes any one or more of the following: an identifier of the communication device, a first indication to turn on or turn off a reflective panel of the communication device, a second indication that indicates whether to update codebook used to control the reflective panel of the communication device, a codebook content or a codebook index, wherein the codebook index is used to correspond to one of plurality of codebooks stored by the communication device, an effective time or an effective time offset of a codebook, configuration of the reflective panel, or a wake-up purpose indication. In some embodiments, the configuration of the reflective panel includes any one or more of the following: a reflective panel index, a reflective panel working mode, a reflective panel configuration cycle, a horizontal steering angle of the reflective panel, a vertical steering angle of the reflective panel, or an effective time or an effective time offset of the configuration of the reflective panel.

A third wireless communication method includes transmitting, by a management function to a network device, control information for a communication device; and receiving, by the management function from the network device, a confirmation that indicates that the communication device received the control information.

In some embodiments, the control information includes any one or more of the following: an identifier of the communication device, a first indication to turn on or turn off a reflective panel of the communication device, a second indication that indicates whether to update codebook used to control the reflective panel of the communication device, a codebook content or a codebook index, wherein the codebook index is used to correspond to one of plurality of codebooks stored by the communication device, an effective time or an effective time offset of a codebook, configuration of the reflective panel, or a wake-up purpose indication. In some embodiments, the configuration of the reflective panel includes any one or more of the following: a reflective panel index, a reflective panel working mode, a reflective panel configuration cycle, a horizontal steering angle of the reflective panel, a vertical steering angle of the reflective panel, or an effective time or an effective time offset of the configuration of the reflective panel.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a scenario of using Reconfigurable Intelligent Surface (RIS) to improve the communication quality and the coverage of the millimeter wave system.

FIG. 2 shows an example timing diagram for sending RIS control information to RIS device through paging.

FIGS. 3 and 4 show an example timing diagrams for a base station to send RIS control information to the RIS control module.

FIG. 5 shows an exemplary block diagram of a hardware platform that may be a part of a network device or a RIS device or a core network device.

FIG. 6 shows an example of wireless communication including a base station (BS) and user equipment (UE) based on some implementations of the disclosed technology.

FIG. 7 shows an example flowchart of configuring a communication device, such as a RIS device or a repeater device.

FIG. 8 shows an example flowchart of transmitting configuration information by a network device (e.g., base station) to a communication device, such as a RIS device or a repeater device.

FIG. 9 shows an example flowchart of transmitting configuration information for a communication device (e.g., a RIS device or a repeater device) by a management function to a network device (e.g., base station).

### DETAILED DESCRIPTION

With the explosive growth of data traffic, millimeter wave (mmWave) has become a key technology of the fifth generation of mobile communications because of its abundant available frequency bands. The first serious challenge to realize millimeter wave communication is path loss. In order to compensate for the serious path loss of millimeter wave transmission, millimeter wave base stations (BS) usually use large-scale antenna arrays for narrow beam transmission, which can effectively transmit energy focused on a certain area or direction. However, millimeter-wave directional transmission is very sensitive to congestion and can even cause connection interruption, which also brings new challenges to the establishment and maintenance of millimeter-wave links. To address at least this technical problem, the Reconfigurable Intelligent Surface (RIS) is integrated into the millimeter wave cellular system.

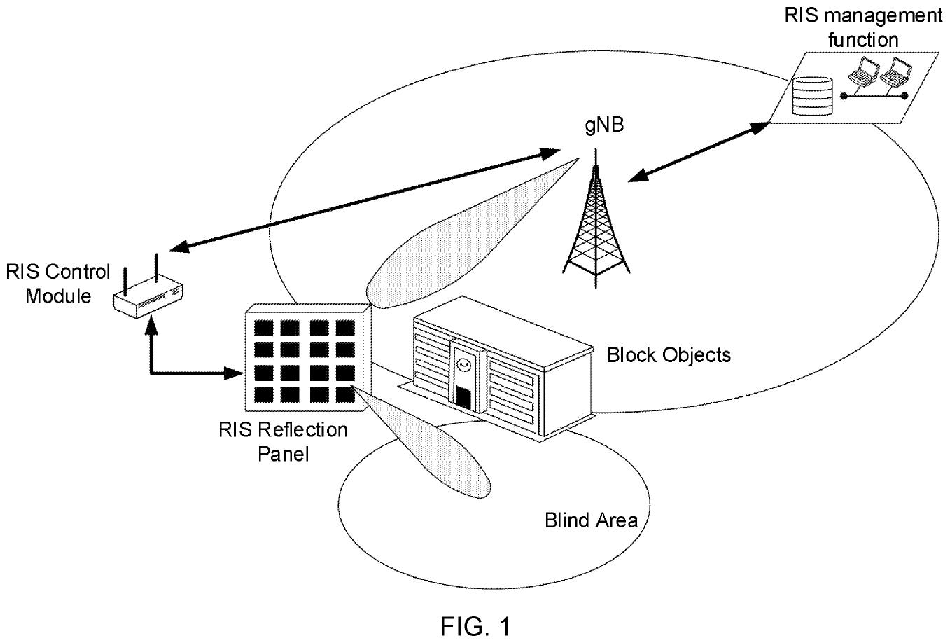

RIS is an antenna surface that contains a large number of low-cost passive reflective elements. Each element can independently adjust the phase and amplitude of the incident electromagnetic wave, thereby changing the propagation path of the electromagnetic wave. Traditional wireless technology generally performs signal processing at the transceiver end to adapt to a dynamic and uncontrollable wireless environment, while RIS can actively correct the wireless channel through a controllable intelligent signal reflection technology. Therefore, RIS provides a new degree of freedom for the further improvement of wireless link performance and paves the way for the realization of an intelligent programmable wireless environment. In the millimeter wave cellular system, the congestion problem can severely reduce the communication quality and even cause the link to be interrupted. With its ability to change the electromagnetic wave transmission environment, RIS has the potential to become a new method to deal with the technical problem of millimeter wave communication congestion. For users whose links with the base station are blocked, the phase of RIS can be adjusted to enable the transmission path of electromagnetic waves to bypass obstructions to reach users, thereby improving the communication quality and the coverage of the millimeter wave system as shown in FIG. 1.

In some cases, RIS is deployed as a supplement to cellular wireless networks. For existing blind spot areas in cellular coverage, RIS can be deployed flexibly to solve the coverage quality of blind spot areas. There are two types of RIS, passive and active. Passive RIS does not need to provide RIS a dedicated power supply line, and therefore the deployment method is simple and the cost is low. However, the codebook of the reflective panel of the passive RIS is fixed and cannot be adjusted, so its reflection angle and beam direction need to be adjusted manually, which lacks deployment flexibility. The active RIS is more flexible in use due to its configurable physical parameters. Active RIS is further divided into active amplifier and reactive amplifier according to whether the reflective panel has active signal amplification function. Among them, the RIS of the reactive amplifier can adopt more flexible power supply methods such as battery power supply because of its low power consumption requirements.

Due to the power consumption of active RIS, its energy-saving performance is an important indicator to test its scope of application. This application proposes several technical solutions that can save energy in response to the wireless demand so that signaling transmission complexity can be reduced and energy consumption in the RIS management process can also be reduced.

In this patent document, a RIS control module is known as RIS device or a communication device. For the RIS control module that enters the idle or inactive state due to power saving, when the RIS management function needs to update the RIS control parameters (such as the reflective panel codebook, or the RIS reflective mode, etc.), and the update action will not happen frequently within a period of time, it is necessary to reduce the overhead and avoid letting RIS go through the complete connection establishment process and release process. The method is as follows:

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only and may be used in wireless systems that implemented other protocols.

### I. TECHNIQUE 1

The RIS management function (shown in FIG. 1), which can also be referred to as repeater management function, sends RIS control information to the first network element (e.g., shown as base station (gNB) in FIG. 1), optionally to inform the first network element of the method used to update the RIS control information. For example, the RIS control information may include information that indicates:
Periodic update, and or update cycle,
Aperiodic update, or temporary update.

The RIS management function may be a part of the core network or it may be associated with or included in a base station. The RIS control information may include the content described in Technique 2 of this patent document.

### II. TECHNIQUE 2

The first network element sends one or more of the following RIS control information to the RIS control module in the RRC idle or inactive state:
RIS identification (or identifier of the RIS control module): the identification that can uniquely distinguish the RIS identity in the cellular network, and can be distinguished from other RISs and UEs based on this, for example, the UE ID of the RIS control module can be used, such as IMSI (International Mobile Subscriber Identification Number, International Mobile Subscriber Identity, corresponding to mobile user identity, namely SIM card identity), IMEI (International Mobile Equipment Identity mobile equipment international identity code, corresponding to terminal equipment identity), S-TMSI (SAE-Temporary Mobile Subscriber Identity, temporary UE identification number), Assigned by the core network), GUTI (Globally Unique Temporary UE Identity, globally unique temporary UE identity, assigned by the core network), or use a newly defined identity,
Turn on/off the RIS reflective panel,
Replace the codebook instruction, the codebook is used to control one or more of the following targets of the reflecting unit of the RIS reflective panel: amplitude control target, phase control target, frequency control target, and polarization control of the incident wave target,
Codebook content or codebook index, where the codebook index is used to correspond to one of the multiple codebooks stored in advance by RIS,
The effective time or time offset of the new codebook,

RIS reflective panel configuration information content, including one or more of the following:
RIS reflective panel serial number (if RIS control module manages multiple reflective panels),
RIS reflective panel working mode: including but not limited to: transmission mode, reflection mode, partial reflection mode (partial transmission, partial reflection),
RIS reflective panel configuration cycle,
Horizontal steering angle of RIS reflective panel,
Vertical steering angle of RIS reflective panel,
Effective time or time offset of RIS reflective panel configuration information,

The measurement configuration of RIS control module to wireless access network;

Indication for wake-up purpose:
Normal wake-up, that is, instructs the RIS control module to go through the complete RRC connection process or RRC resume process;
Temporary wake-up, which means that the RIS control module does not need to go through a complete RRC connection process or RRC resume process. After the RIS receives the control information, it can return to the idle state or the inactive state;
The above indications for wake-up purpose can also indicate “whether there is subsequent data to be transmitted” (there is subsequent data to be transmitted by the first network element and received by the RIS device, which means that the RIS control module is required to establish an RRC connection to complete the subsequent data transmission and reception).

### III. TECHNIQUE 3

The first network element sends one or more of the following RIS control information to the RIS control module in the RRC idle or inactive state using any one of the following methods:

Method 1: Send the RIS control information through paging; specifically including:

Send the RIS control information through one or more paging signaling or one or more paging messages. In current technology, a paging message includes an identifier of a terminal and an access type information. However, in current technology, the paging message sent to a wireless device does not include control information. The methods in Technique 3 efficiently indicate RIS control information via a paging message to the RIS control module so that the RIS control module can be more efficiently configured compared to current technology.
Optionally, the number of transmissions to be received by the RIS control module is pre-configured by the first network element and notified to the RIS control module through system messages (e.g., system information block (SIB) messages broadcast by first network element) or dedicated signaling (e.g., radio resource control (RRC) message sent by the first network element to the RIS control module).

Method 2: Inform the RIS control module of new RIS control information through paging, and issue the RIS control information content through the random-access process initiated by the RIS control module.

If the 4-step random access process is adopted, the RIS control information content will be issued in msg2 or msg4 of the random access process;

If the 2-step random access process is adopted, the RIS control information content will be issued in msgB;

Among them, the first network element can configure a dedicated preamble resource or PRACH resource for the RIS, and send it to the RIS through a system message to assist the first network element to distinguish whether it is the RIS that initiated the random access.

Method 3: Send the RIS control information to the RIS control module (for example, using configured grant resources) through pre-configured/pre-scheduled wireless resources

The pre-configured/pre-scheduled resources include scheduling information for wireless time domain resources and frequency domain resources.

The pre-configured/pre-scheduled resource is sent to the control module of the RIS when the RIS control module is in the RRC connection state last time, for example, sent through a dedicated signaling RRC release message.

The pre-configured/pre-scheduled resources are only valid during the time that the RIS control module and the base station can maintain synchronization. When synchronization is lost, the pre-configured/pre-scheduled resources cannot be used.

The time that the RIS control module can maintain synchronization with the base station can be controlled by a timer. When the timer is running, the RIS control module and the base station think that the synchronization is maintained normally; when the timer expires, the RIS control module and the base station think synchronization is lost; the length of the timer is configured by the base station and sent to the RIS control module.

The RIS control module in the RRC idle or inactive state monitors whether there is scheduling signaling and data information sent to itself on the pre-configured/pre-scheduled resources.

### IV. TECHNIQUE 4

Optionally, the first network element and the RIS control module may explicitly or implicitly agree: whether the RIS control module feeds back confirmation information to the first network element to express whether the RIS control information is successfully received.

If an explicit agreement is adopted, the first network element can send to the RIS control module through system messages, dedicated signaling, or along with the RIS control information, to inform the RIS control module whether it needs to feedback confirmation information to express whether the RIS control information is successfully received.

If an implicit agreement method is adopted, it can be determined through an agreement whether the RIS control module needs to provide feedback to the confirmation information to express whether the RIS control information is successfully received.

### V. TECHNIQUE 5

The methods for the RIS control module to feedback confirmation information to the first network element to express whether the RIS control information is successfully received includes one of the following:

If the RIS control information is received in paging, the methods for the RIS control module to feedback and confirm receipt of the information include:
The first network element configures a dedicated random-access preamble or physical RACH resource for the RIS control module. When the RIS control module successfully receives the RIS control information, it uses the dedicated random-access preamble or physical RACH resource to express the successful receipt;
Feedback the acknowledged receipt information through the msg3 or msg5 of the random-access process initiated by the RIS control module;
Feedback the acknowledged receipt information through pre-configured/pre-scheduled wireless resources.

If the RIS control information is received in msg2 of the 4-step random access process, the RIS control module feedbacks the confirmation receipt information through msg3 or msg5;
If the RIS control information is received in msgB of the 2-step random access process, the RIS control module uses the ACK/NACK feedback corresponding to msgB to indicate whether the RIS control information is successfully received, or feedback in the first uplink message after msgB is received, where the first uplink message indicates whether the RIS control information is successfully received;
If the RIS control information is received in the pre-configured/pre-scheduled wireless resource, the RIS control module uses the ACK/NACK feedback corresponding to the pre-configured/pre-scheduled wireless resource to indicate whether it successfully received the RIS control information.

### VI. EXAMPLE EMBODIMENTS FOR METHODS DESCRIBED IN TECHNIQUE 3

### (a)Embodiment 1: Sending RIS Control Information Through Paging

This embodiment describes Method 1 of Technique 3: sending the RIS control information through paging.

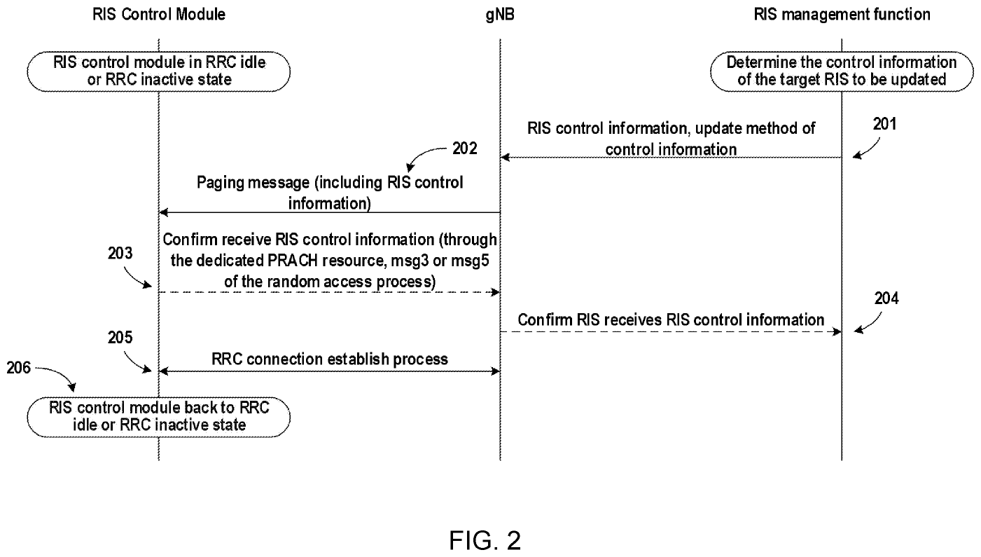

FIG. 2 shows an example timing diagram for sending RIS control information through paging to the RIS device.

The first network element is the 5G base station gNB. The RIS management function is controlled by the RIS manager. The RIS management function sends control instructions to RIS and updates the codebook of the RIS reflection panel.

Operation 201: The RIS management function sends RIS control information to the target RIS. The control information is first sent to the gNB, and then forwarded to the target RIS via the gNB; optionally, the RIS management function can inform the gNB of the update method of the RIS control information:

Periodic update, and/or update cycle.

Aperiodic update, or temporary update.

Or whether there is follow-up data to be sent.

The RIS control information includes one or more of the following:

RIS identification: the identification that can uniquely distinguish the RIS identity in the cellular network and can be distinguished from other RIS and UE based on this. For example, the UE ID of the RIS control module can be used, such as IMSI (International Mobile Subscriber Identification Number, International Mobile User identification code, corresponding to mobile user identity, namely SIM card identity), IMEI (International Mobile Equipment Identity mobile equipment international identity code, corresponding to terminal equipment identity), S-TMSI (SAE-Temporary Mobile Subscriber Identity, temporary UE identification number, by Core network allocation), GUTI (Globally Unique Temporary UE Identity, globally unique temporary UE identity, allocated by the core network), or use a newly defined identity.

On/off RIS reflective panel.

Replace codebook instructions, the codebook is used to control one or more of the following targets of the reflection unit of the RIS reflective panel: amplitude control target, phase control target, frequency control target, and polarization control target of the incident wave.

Codebook content or codebook index, where the codebook index is used to correspond to one of the multiple codebooks stored in advance by RIS.

The effective time or time offset of the new codebook.

Instructions for changing the RIS configuration: whether this command is used to change the RIS configuration.

The configuration information of RIS reflective panel, including one or more of the following:
RIS reflective panel serial number (if RIS control module manages multiple reflective panels)
RIS reflective panel working mode: including but not limited to: transmission mode, reflection mode, partial reflection mode (partial transmission, partial reflection)
RIS reflective panel configuration cycle
Horizontal steering angle of RIS reflective panel
Vertical steering angle of RIS reflective panel
Effective time or time offset of configuration information of RIS reflective panel

Measurement configuration of RIS control module to wireless access network.

Operation 202: The gNB forwards the control information, from the RIS management function, to the RIS control module in the RRC idle or inactive state. In addition, the gNB can determine, based on its estimation of frequency of sending control messages from the RIS management function, after the RIS control module awakening this time, whether the RIS control module is required to establish a complete RRC connection, or only a temporary information delivery is completed. Based on this, gNB can issue a wake-up purpose indication to the RIS control module:
Normal wake-up, that is, instruct the RIS control module to complete the complete RRC connection establishment process or RRC resume (RRC connection resume) process;
Temporarily wake up, which means that the RIS control module does not need to do a complete RRC connection process or resume process. After the RIS receives the control information, it can return to the idle state or inactive state;
The above wake-up purpose indication can also be expressed as: whether there is subsequent data to be transmitted (there is subsequent data to be transmitted, which means that the RIS control module is required to establish an RRC connection to complete the subsequent data transmission and reception).

The gNB sends the RIS control information and or wake-up purpose indication through one or more paging messages. The number of paging transmissions is pre-configured by the gNB, and the system message or dedicated signaling is used to inform RIS control module in advance.

The gNB can explicitly or implicitly agree with the RIS control module about whether the RIS control module sends back confirmation information to the gNB to express whether the RIS control information is successfully received. For example, when the gNB considers that the quality of the wireless channel with the RIS control module is stable, where even the paging message is sent multiple times, the packet error rate of information transmission is extremely low, so it can be agreed that the RIS control module does not need to feedback confirmation information to express whether the RIS control information is successfully received.

The agreement can be sent to the RIS control module along with the RIS control information in a paging message or can be sent to the RIS control module in a system message.

Operation 203: If the RIS control module successfully receives the RIS control information and the gNB requires feedback of confirmation information, if the confirmation information needs to be feedbacked, the RIS control module can give feedback through the following methods:
gNB configures a dedicated random-access preamble or physical RACH resource for the RIS control module. When the RIS control module successfully receives the RIS control information, it uses the dedicated random-access preamble or physical RACH resource to express the successful receipt (in the existing 5G NR protocol, this is the first step of random access, so it can also be called msg1. Correspondingly, the feedback of gNB to msg1 is the second step of random access, and in the 5G NR protocol it can also be called msg2, and the meanings of subsequent msg3, 4, and 5 can be deduced by analogy); or,
The msg3 or msg5 of the random-access process initiated by the RIS control module feeds back the acknowledgement information;
Feedback the received confirmation message through gNB pre-configured/pre-scheduled wireless resources.

If the RIS control information is not successfully received, that is, the RIS control module has not successfully received the paging message carrying the RIS control information, the RIS control module does not need to take a feedback action.

Operation 204: If the gNB receives the “confirmation of receipt of RIS control information” feedback from the RIS control module, optionally, the gNB sends a “confirmation of receipt of RIS control information” message to the RIS management function.

Operation 205: The RIS control module determines whether this access needs to establish an RRC connection with gNB according to the gNB instruction. If the gNB indicates that this access is a normal wake-up (that is, an RRC connection needs to be established), the RIS control module will continue to complete the RRC establishment process after the random access. If the gNB indicates that this access is temporarily awakened (that is, there is no need to establish an RRC connection), the RIS control module goes to step 206.

Operation 206: The RIS control module returns to the RRC idle or RRC inactive state.

### (b)Embodiment 2—Send RIS Control Information Through Random Access Process

The real-time scenario is the same as in Embodiment 1. This embodiment describes the Method 2 of Technique 3 for the gNB to send RIS control information to the RIS control module.

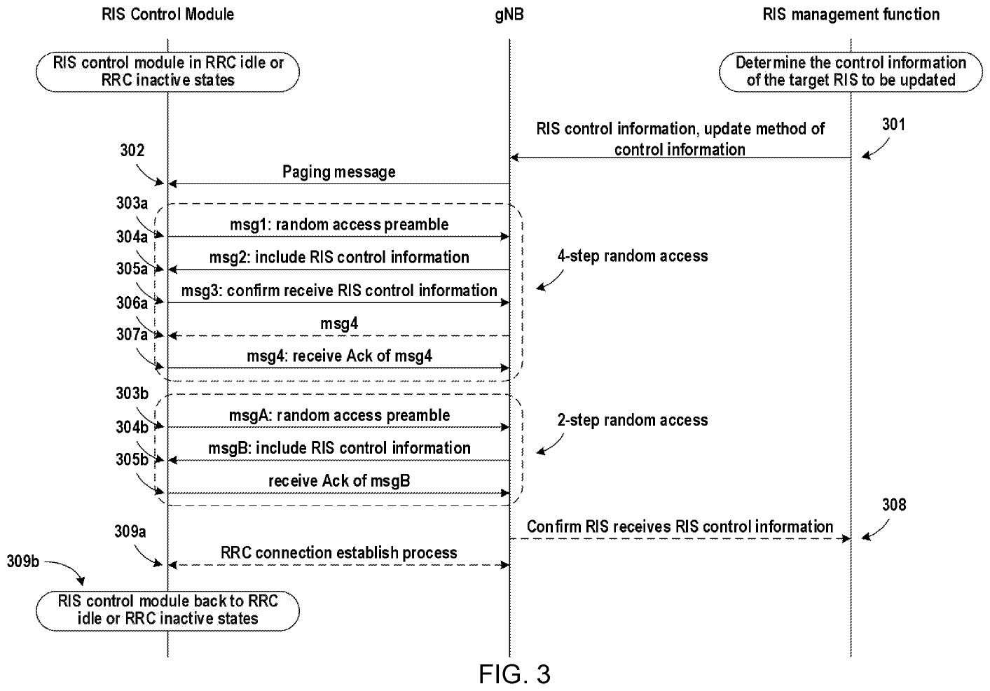

FIG. 3 shows an example timing diagram for a base station (gNB) to send RIS control information to the RIS control module.

Operation 301: Same as step 201 in embodiment 1.

Operation 302: The gNB wakes up the RIS control module in the RRC idle or RRC inactive state through a paging message; optionally, the paging message can carry an indication to inform the RIS control module of new RIS control information.

Operation 303a: After receiving the paging, the RIS control module initiates a random-access process to the gNB; the gNB issues the RIS control information content during the random-access process. To assist the gNB in identifying whether it is a random access initiated by RIS, the gNB can configure a preamble or PRACH resources dedicated to the RIS and broadcast them to the RIS through a system message.

Currently, the 5G NR protocol supports two random access procedures, one is the 4-step random access process, and the other is the 2-step random access process.

If the 4-step random access process is adopted, see 303a-307a for the process, the gNB issues the RIS control information in msg2 or msg4 of the 4-step random access process.

If the 2-step random access process is adopted, see steps 303b˜306b for the process, the gNB issues the RIS control information in msgB of the 2-step random access process.

Operation 304a: After receiving the random-access preamble, the gNB determines whether the access uses dedicated RIS preamble or PRACH resources. If so, gNB can issue RIS control information in msg2; optionally, it can also issue RIS control in msg4 information.

Operation 305a: If RIS control information is received, RIS can feedback “confirm receipt of RIS control information” instruction in msg3.

Operation 306a: gNB sends msg4, optionally, if gNB does not send RIS control information in msg2, the RIS control information can also be sent in msg4.

Operation 307a: If RIS successfully receives msg4, RIS sends feedback ACK to gNB (belonging to HARQ (hybrid retransmission) mechanism acknowledgement received feedback)

Operation 303b: After receiving paging, the RIS control module uses the 2-step random access process to send msgA to gNB.

Operation 304b: gNB receives msgA and determines whether the access uses dedicated RIS preamble or PRACH resources. If so, gNB can issue RIS control information in msgB.

Operation 305b: If RIS successfully receives msgB, RIS will send feedback ACK to gNB (belonging to the HARQ (hybrid retransmission) mechanism acknowledgement received feedback).

Operation 308: gNB confirms that RIS has received RIS control information. Optionally, gNB sends a message “confirm that RIS has received RIS control information” to the RIS management function.

Operation 309a: RIS control module determines, according to gNB instruction, whether this access needs to establish an RRC connection with the gNB. If the gNB indicates that this access is a normal wake-up (that is, an RRC connection needs to be established), the RIS control module will continue to complete the RRC establishment process after completing the random-access process.

If the gNB indicates that this access is a temporary wake-up (that is, there is no need to establish an RRC connection), the RIS control module goes to step 309b.

Operation 309a: RIS control module according to gNB instruction.

### (c)Embodiment 3: Sending RIS Control Information Through Pre-Configured Resources

The real-time scenario is the same as in Embodiment 1. This embodiment describes the Method 3 of Technique 3 for the gNB to send RIS control information to the RIS control module.

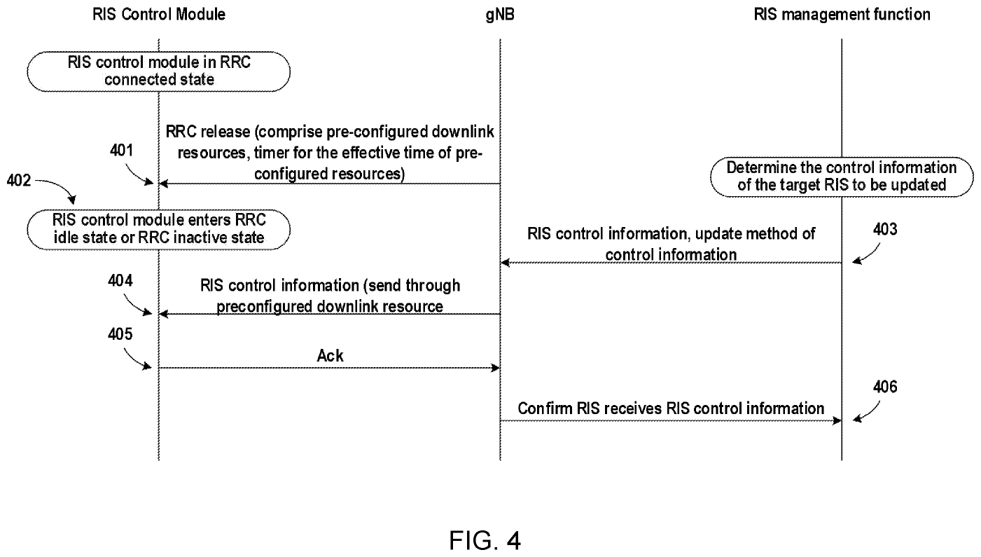

FIG. 4 shows another example timing diagram for a base station (gNB) to send RIS control information to the RIS control module.

Operation 401: At the end of the last RRC connection process of the RIS control module, the gNB configures the RIS control module with “pre-configured” downlink resources and the effective time timer of the pre-configured resources through the RRC release message.

The pre-configured/pre-scheduled resources include scheduling information for wireless time domain resources and frequency domain resources.

The pre-configured/pre-scheduled resources are only valid during the time that the RIS control module and the base station can maintain synchronization, and when synchronization is lost, the pre-configured/pre-scheduled resources cannot be used.

Operation 402: The RIS control module enters the RRC idle or RRC inactive state.

Operation 403: Same as step 201 in embodiment 1.

Operation 404: If the effective time of the pre-configured downlink resource configured to the RIS control module does not expire, the gNB sends the RIS control information to the RIS control module through the pre-configured downlink resource.

If it has timed out, gNB can choose the method of embodiment 1 or 2 to send the RIS control information to the RIS control module.

In the same example, assuming that there is no timeout, the gNB sends the RIS control information to the RIS control module through the pre-configured downlink resource.

Operation 405: The RIS control module monitors whether downlink data is sent on the preconfigured downlink resource within the effective time of the preconfigured downlink resource. If the RIS control information is successfully received, the RIS control module feedbacks an ACK to the gNB. If the downlink data is not monitored, the RIS control module performs no additional operations.

Operation 406: gNB confirms that RIS has received RIS control information. Optionally, it sends a message “confirm that RIS has received RIS control information” to the RIS management function.

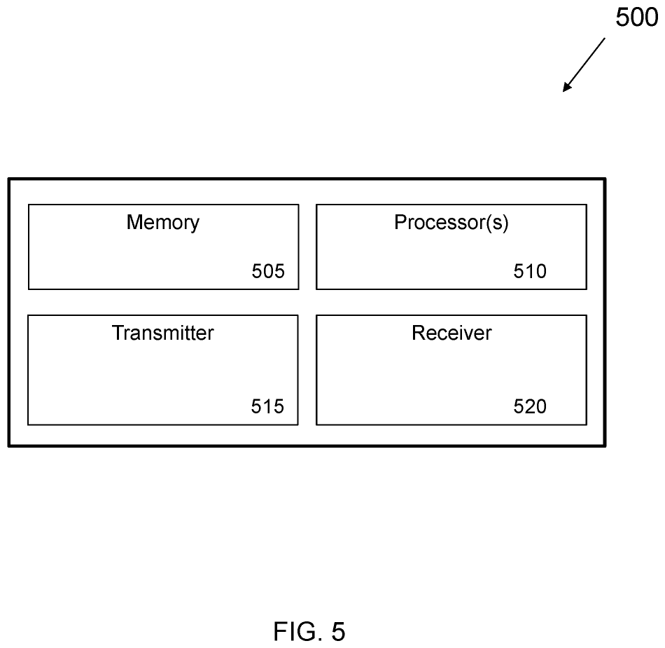

FIG. 5 shows an exemplary block diagram of a hardware platform 500 that may be a part of a network device (e.g., base station) or a RIS device (e.g., RIS control module) or a core network device (e.g., that includes or operates the RIS management function). The hardware platform 500 includes at least one processor 510 and a memory 505 having instructions stored thereupon. The instructions upon execution by the processor 510 configure the hardware platform 500 to perform the operations described in FIGS. 1 to 4 and 7 to 9 and in the various embodiments described in this patent document. The transmitter 515 transmits or sends information or data to another device. For example, a network device transmitter can send a message to a RIS device. The receiver 520 receives information or data transmitted or sent by the network device. For example, a RIS device can receive a message from a network device.

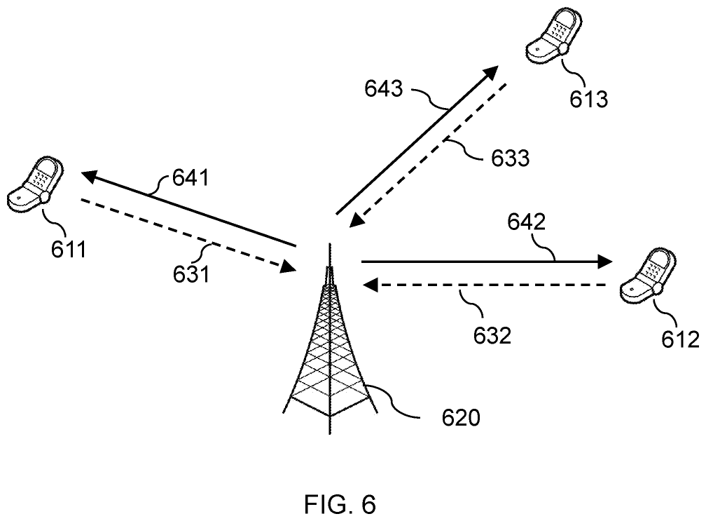

The implementations as discussed above will apply to a wireless communication. FIG. 6 shows an example of a wireless communication system (e.g., a 5G or NR cellular network) that includes a base station 620 and one or more user equipment (UE) 611, 612 and 613. In some embodiments, the UEs access the BS (e.g., the network) using a communication link to the network (sometimes called uplink direction, as depicted by dashed arrows 631, 632, 633), which then enables subsequent communication (e.g., shown in the direction from the network to the UEs, sometimes called downlink direction, shown by arrows 641, 642, 643) from the BS to the UEs. In some embodiments, the BS send information to the UEs (sometimes called downlink direction, as depicted by arrows 641, 642, 643), which then enables subsequent communication (e.g., shown in the direction from the UEs to the BS, sometimes called uplink direction, shown by dashed arrows 631, 632, 633) from the UEs to the BS. The UE and the BS can communicate with each other (in the uplink direction or the downlink direction) via the RIS device as described in this patent document. The UE may be, for example, a smartphone, a tablet, a mobile computer, a machine to machine (M2M) device, an Internet of Things (IoT) device, and so on.

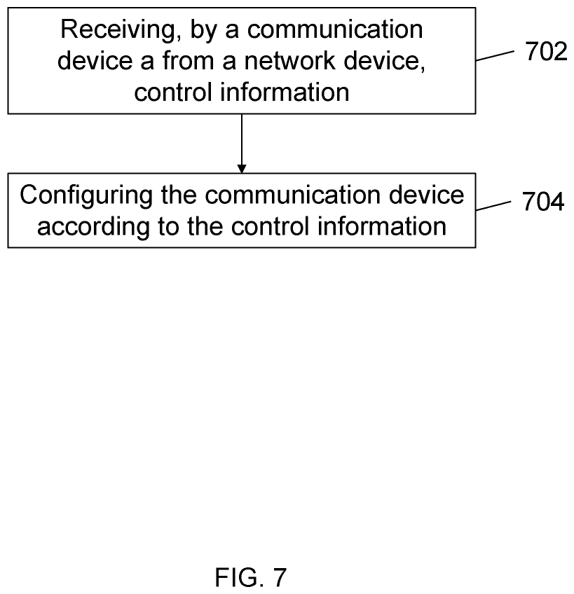

FIG. 7 shows an example flowchart of configuring a communication device, such as a RIS device or a repeater device. Operation 702 includes receiving, by a communication device a from a network device, control information. Operation 704 includes configuring the communication device according to the control information.

In some embodiments, a number of transmissions of the control information to be received by the communication device is pre-configured, and the communication device receives from the network device a system message or a dedicated message that indicates the number of transmissions. In some embodiments, the control information is included in a paging message. In some embodiments, the method further comprises receiving, by a communication device from a network device, a paging message that indicates that control information is available for the communication device; initiating, by the communication device, a random access procedure in response to receiving the paging message; and receiving, by the communication device, the control information during the random access procedure.

In some embodiments, the control information is included in msg2 or msg4 in case that the random access procedure being a 4-step random access procedure. In some embodiments, the control information is included in msgB in case that the random access procedure being a 2-step random access procedure. In some embodiments, the communication device initiates the random access procedure using a physical random access channel resource (PRACH) resource dedicated for a reconfigurable intelligent surface (RIS) device, and the PRACH resource is received by the communication device and configured by the network device. In some embodiments, the control information is received using pre-configured downlink resources or pre-scheduled resources. In some embodiments, the pre-configured downlink resources or the pre-scheduled resources include time domain resources and frequency domain resources.

In some embodiments, the pre-configured downlink resources or the pre-scheduled resources are received by the communication device when the communication device is in a radio resource control (RRC) connected state prior to the receiving the control information, and the communication device receives from the network device a system message or a dedicated message that indicates the pre-configured downlink resources or the pre-scheduled resources. In some embodiments, the pre-configured downlink resources or the pre-scheduled resources are valid during a time when the communication device operates a timer that has not expired which indicates that the communication device is synchronized with the network device. In some embodiments, a length of the time is configured by the network device and is received by the communication device from the network device.

In some embodiments, the communication device receives the control information during a radio resource control (RRC) idle state or a RRC inactive state by monitoring for signaling that includes the control information on the pre-configured downlink resources or on the pre-scheduled resources. In some embodiments, the control information includes any one or more of the following: an identifier of the communication device, a first indication to turn on or turn off an RIS reflective panel of the communication device, a second indication that indicates whether to update codebook used to control the RIS reflective panel of the communication device, a codebook content or a codebook index, wherein the codebook index is used to correspond to one of plurality of codebooks stored by the communication device, an effective time or an effective time offset of a codebook, configuration of the RIS reflective panel, or a wake-up purpose indication.

In some embodiments, the configuration of the RIS reflective panel includes any one or more of the following: a RIS reflective panel index, a RIS reflective panel working mode, a RIS reflective panel configuration cycle, a horizontal steering angle of the RIS reflective panel, a vertical steering angle of the RIS reflective panel, or an effective time or an effective time offset of the configuration of the RIS reflective panel. In some embodiments, the wake-up purpose indication indicates whether there is a subsequent information to be received by the communication device, or the wake-up purpose indication includes: a normal wake-up indication that indicates to the communication device to complete a radio resource control (RRC) connection procedure or RRC resume procedure, or a temporary wake-up that indicates to the communication device that the communication device does not need to complete the RRC connection procedure or the RRC resume procedure.

In some embodiments, the communication device sends to the network device a feedback message that indicates that the communication device received the control information in a paging message, and the feedback message is sent by using a dedicated random access preamble configured by the network device or by using a dedicated physical random access channel resource (RACH) configured by the network device for the communication device. In some embodiments, the communication device sends to the network device a feedback message that indicates that the communication device received the control information, and the feedback message is sent in msg3 or msg5 of the 4-step random access procedure. In some embodiments, the communication device sends to the network device a feedback message that indicates that the communication device received the control information, and the feedback message is sent by using network pre-configured uplink wireless resources or pre-scheduled uplink wireless resources.

In some embodiments, the communication device sends to the network device a feedback message that indicates that the communication device received the control information, and the feedback message is sent using a hybrid automatic repeat request (HARQ) acknowledgement/non-acknowledgement (ACK/NACK) response corresponding to the msgB of the 2-step random access procedure in case the control information is received in the msgB. In some embodiments, the communication device sends to the network device a feedback message that indicates that the communication device received the control information, and the feedback message is sent with an acknowledgement (ACK) or non-acknowledgement (NACK) feedback corresponding to the pre-configured downlink resources or the pre-scheduled downlink resources. In some embodiments, the communication device includes a reconfigurable intelligent surface (RIS) device or a repeater device.

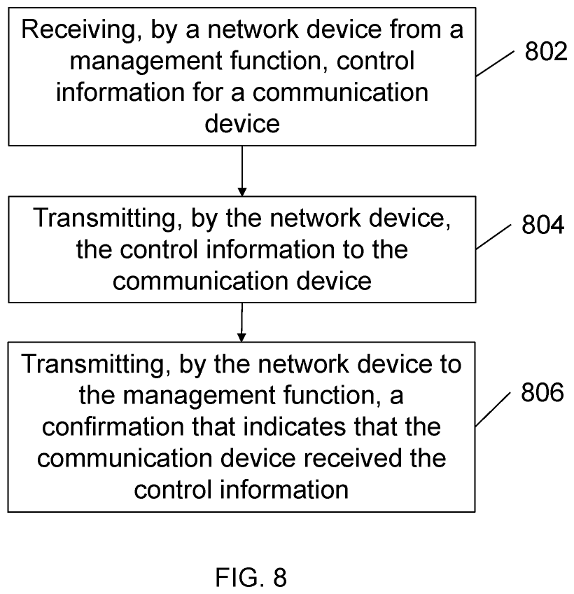

FIG. 8 shows an example flowchart of transmitting configuration information by a network device (e.g., base station) to a communication device, such as a RIS device or a repeater device. Operation 802 includes receiving, by a network device from a management function (or a device comprising the management function (e.g., device comprising RIS management function), control information for a communication device. Operation 804 includes transmitting, by the network device, the control information to the communication device. Operation 806 includes transmitting, by the network device to the core network device, a confirmation that indicates that the communication device received the control information.

In some embodiments, the control information is included in a paging message. In some embodiments, the control information is included in msg2 or msg4 in case that a random access procedure between the network device and the communication device being a 4-step random access procedure. In some embodiments, the control information is included in msgB in case that a random access procedure between the network device and the communication device being a 2-step random access procedure. In some embodiments, the control information is transmitted using pre-configured downlink resources or pre-scheduled resources.

In some embodiments, the control information includes any one or more of the following: an identifier of the communication device, a first indication to turn on or turn off a reflective panel of the communication device, a second indication that indicates whether to update codebook used to control the reflective panel of the communication device, a codebook content or a codebook index, wherein the codebook index is used to correspond to one of plurality of codebooks stored by the communication device, an effective time or an effective time offset of a codebook, configuration of the reflective panel, or a wake-up purpose indication. In some embodiments, the configuration of the reflective panel includes any one or more of the following: a reflective panel index, a reflective panel working mode, a reflective panel configuration cycle, a horizontal steering angle of the reflective panel, a vertical steering angle of the reflective panel, or an effective time or an effective time offset of the configuration of the reflective panel.

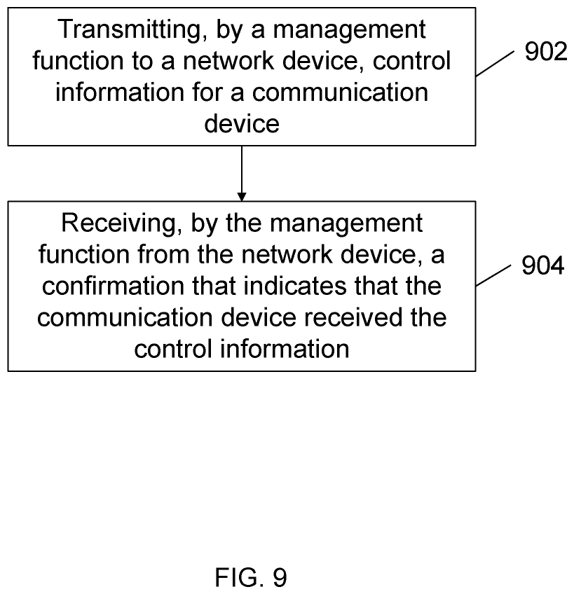

FIG. 9 shows an example flowchart of transmitting configuration information for a communication device (e.g., a RIS device or a repeater device) by a management function to a network device (e.g., base station). Operation 902 includes transmitting, by a management function to a network device, control information for a communication device. Operation 904 includes receiving, by the core network device from the network device, a confirmation that indicates that the communication device received the control information.

In some embodiments, the control information includes any one or more of the following: an identifier of the communication device, a first indication to turn on or turn off a reflective panel of the communication device, a second indication that indicates whether to update codebook used to control the reflective panel of the communication device, a codebook content or a codebook index, wherein the codebook index is used to correspond to one of plurality of codebooks stored by the communication device, an effective time or an effective time offset of a codebook, configuration of the reflective panel, or a wake-up purpose indication. In some embodiments, the configuration of the reflective panel includes any one or more of the following: a reflective panel index, a reflective panel working mode, a reflective panel configuration cycle, a horizontal steering angle of the reflective panel, a vertical steering angle of the reflective panel, or an effective time or an effective time offset of the configuration of the reflective panel.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements and variations can be made based on what is described and illustrated in this disclosure.

1. A wireless communication method, comprising:
receiving, by a communication device a from a network device, control information; and
configuring the communication device according to the control information.

2. The method of claim 1,
wherein a number of transmissions of the control information to be received by the communication device is pre-configured, and
wherein the communication device receives from the network device a system message or a dedicated message that indicates the number of transmissions;
or, wherein the control information is included in a paging message.

3. (canceled)

4. The method of claim 1, further comprising:
receiving, by a communication device from a network device, a paging message that indicates that control information is available for the communication device;
initiating, by the communication device, a random access procedure in response to receiving the paging message; and
receiving, by the communication device, the control information during the random access procedure;
or, wherein the control information is included in msg2 or msg4 in case that the random access procedure being a 4-step random access procedure;
or, wherein the control information is included in msgB in case that the random access procedure being a 2-step random access procedure.

5. (canceled)

6. (canceled)

7. The method of claim 4,
wherein the communication device initiates the random access procedure using a physical random access channel resource (PRACH) resource dedicated for a reconfigurable intelligent surface (RIS) device, and
wherein the PRACH resource is received by the communication device and configured by the network device.

8. The method of claim 1, wherein the control information is received using pre-configured downlink resources or pre-scheduled resources;
or, wherein the pre-configured downlink resources or the pre-scheduled resources include time domain resources and frequency domain resources.

9. (canceled)

10. The method of claim 8,
wherein the pre-configured downlink resources or the pre-scheduled resources are received by the communication device when the communication device is in a radio resource control (RRC) connected state prior to the receiving the control information, and
wherein the communication device receives from the network device a system message or a dedicated message that indicates the pre-configured downlink resources or the pre-scheduled resources.

11. The method of claim 8, wherein the pre-configured downlink resources or the pre-scheduled resources are valid during a time when the communication device operates a timer that has not expired which indicates that the communication device is synchronized with the network device;
or, wherein a length of the time is configured by the network device and is received by the communication device from the network device;
or, wherein the communication device receives the control information during a radio resource control (RRC) idle state or a RRC inactive state by monitoring for signaling that includes the control information on the pre-configured downlink resources or on the pre-scheduled resources.

12. (canceled)

13. (canceled)

14. The method of claim 1, wherein the control information includes any one or more of the following:
an identifier of the communication device,
a first indication to turn on or turn off an RIS reflective panel of the communication device,
a second indication that indicates whether to update codebook used to control the RIS reflective panel of the communication device,
a codebook content or a codebook index, wherein the codebook index is used to correspond to one of plurality of codebooks stored by the communication device,
an effective time or an effective time offset of a codebook,
configuration of the RIS reflective panel, or
a wake-up purpose indication.

15. The method of claim 14, wherein the configuration of the RIS reflective panel includes any one or more of the following:
a RIS reflective panel index,
a RIS reflective panel working mode,
a RIS reflective panel configuration cycle,
a horizontal steering angle of the RIS reflective panel,
a vertical steering angle of the RIS reflective panel, or
an effective time or an effective time offset of the configuration of the RIS reflective panel.

16. The method of claim 14,
wherein the wake-up purpose indication indicates whether there is a subsequent information to be received by the communication device, or
wherein the wake-up purpose indication includes:
a normal wake-up indication that indicates to the communication device to complete a radio resource control (RRC) connection procedure or RRC resume procedure, or
a temporary wake-up that indicates to the communication device that the communication device does not need to complete the RRC connection procedure or the RRC resume procedure.

17. The method of claim 1,
wherein the communication device sends to the network device a feedback message that indicates that the communication device received the control information in a paging message, and
wherein the feedback message is sent by using a dedicated random access preamble configured by the network device or by using a dedicated physical random access channel resource (RACH) configured by the network device for the communication device.

18. The method of claim 4,
wherein the communication device sends to the network device a feedback message that indicates that the communication device received the control information, and
wherein the feedback message is sent in msg3 or msg5 of the 4-step random access procedure.

19. The method of claim 1,
wherein the communication device sends to the network device a feedback message that indicates that the communication device received the control information, and
wherein the feedback message is sent by using network pre-configured uplink wireless resources or pre-scheduled uplink wireless resources.

20. The method of claim 4,
wherein the communication device sends to the network device a feedback message that indicates that the communication device received the control information, and
wherein the feedback message is sent using a hybrid automatic repeat request (HARQ) acknowledgement/non-acknowledgement (ACK/NACK) response corresponding to the msgB of the 2-step random access procedure in case the control information is received in the msgB.

21. The method of claim 8,
wherein the communication device sends to the network device a feedback message that indicates that the communication device received the control information, and
wherein the feedback message is sent with an acknowledgement (ACK) or non-acknowledgement (NACK) feedback corresponding to the pre-configured downlink resources or the pre-scheduled downlink resources.

22. A wireless communication method, comprising:
receiving, by a network device from a management function, control information for a communication device;
transmitting, by the network device, the control information to the communication device; and
transmitting, by the network device to the management function, a confirmation that indicates that the communication device received the control information.

23. The method of claim 22, wherein the control information is included in a paging message;
or, wherein the control information is included in msg2 or msg4 in case that a random access procedure between the network device and the communication device being a 4-step random access procedure;
or, wherein the control information is included in msgB in case that a random access procedure between the network device and the communication device being a 2-step random access procedure;
or, wherein the control information is transmitted using pre-configured downlink resources or pre-scheduled resources.

24. (canceled)

25. (canceled)

26. (canceled)

27. (canceled)

28. (canceled)

29. A wireless communication method, comprising:
transmitting, by a management function to a network device, control information for a communication device; and
receiving, by the management function from the network device, a confirmation that indicates that the communication device received the control information.

30. (canceled)

31. (canceled)

32. The method of claim 1, wherein the communication device includes a reconfigurable intelligent surface (RIS) device or a repeater device.

33. (canceled)

34. A non-transitory computer readable program storage medium having code stored thereon, the code, when executed by a processor, causing the processor to implement a method recited in claim 1.
